(19) United States
(12) Patent Application Publication
(10) Pub. No.: US 2018/0231798 A1
(43) Pub. Date: Aug. 16, 2018

(54) FLOATABLE TEMPLE STRUCTURE OF EYEGLASSES

(71) Applicant: HSIEN CHANG OPTICAL INDUSTRIAL CO., LTD., TAINAN (TW)

(72) Inventor: WEN-HSIUNG CHOU, TAINAN (TW)

(21) Appl. No.: 15/429,518

(22) Filed: Feb. 10, 2017

(51) Int. Cl. G02C 5/00; G02C 5/14

(52) U.S. Cl. CPC G02C 5/008; G02C 2200/14; G02C 5/14

(57) ABSTRACT

A floatable structure of eyeglasses temple is provided. The floatable structure includes a temple body, a cover sheet, and a coating member. The temple body has a first space, and an opening of the first space is correspondingly assembled and covered by the cover sheet. The cover sheet has a second space to correspond to the first space. The coating member covers the external parts of the temple body and the cover sheet. Therefore, a gas-filling space is formed inside the temple structure. The temple can float on water after glasses fall into the water, so that the glasses can be found easily.

### BACKGROUND

### Field of Invention

The disclosure relates to a floatable temple structure of eyeglasses. More particularly, the disclosure relates to a floatable temple structure of eyeglasses that has a gas-filling space therein.

### Description of Related Art

Water activities include any sports, leisure and work activities in the water, at the water sides, and on the water. For example, water activities can be fishing, swimming, diving, water volleyball, surfing, water motorcycles, and even water ballet and so on. Since the water activities contribute to muscle activity, sweating, tendons and bones stretching, cardiopulmonary function enhancement, and other benefits, the water activities become causal hobbies of many people.

Because many people have myopia, hyperopia, astigmatism, or for shading purposes, or to avoid water into the eyes, they still need to wear eyeglasses when the water activities are in progress. However, when the water activities are too intense or people are inadvertent, eyeglasses may fall into water. Since the eyeglasses have a considerable density, the eyeglasses easily sink into the water and thus cannot be easily found. Therefore, it causes inconvenience for the users, and it even causes dangers.

Accordingly, Taiwan patent number M241662, a structure of eyeglasses used in water activities, was granted. The eyeglasses comprise a frame part and a wearing part. The frame part comprises a frame body having lenses inserted into the inner edges of the frame body. The features include a hollow room disposed in the lens bodies, so that the lens bodies as well as the eyeglasses can have floatability on the water. The main design of eyeglasses is the hollow room disposed in the lens body. The hollow room is disposed between two clip layers of the lens, and the two clip layers are closely attached by a spacer frame made by a high airtight material. Or, the lens may be blown and then separated by the spacer frame to form the hollow room. Therefore, when a user is engaged in water activities and the eyeglasses fall into the water, the hollow lens allows the eyeglasses to float on the water. Hence, the user can find the eyeglasses quickly.

However, the main design of the eyeglasses in TW M241662 is the hollow room in the lens. Although the eyeglasses can float on water, the lenses cannot be easily made when the lenses, such as optical lenses, are used to correct myopia, hyperopia, and astigmatism. Thus, the eyeglasses disclosed in TW M241662 have the drawback of difficult production.

Therefore, in view of drawbacks of the conventional structures, the inventors develop this invention by the many-year manufacturing and design experience and knowledge in the related fields and ingenuity to provide a floatable structure of eyeglasses temples.

### SUMMARY

An aspect of this invention is to provide a floatable structure of eyeglasses temple, especially a floatable temple structure of eyeglasses that has a gas space therein.

The aspects and functions are mainly accomplished by the following technical means.

The floatable temple structure includes a temple body, a cover sheet, and a coating member. The temple body has a first space, and the opening of the first space is correspondingly assembled and covered by the cover sheet. The cover sheet has a second space to correspond to the first space. The coating member covers the external parts of the temple body and the cover sheet. Therefore, a gas-filling space is formed inside the temple structure. The temple can float on water after glasses fall into the water, so that the glasses can be find easily.

In the floatable temple structure above, an opening of the first space has a stepped rim disposed on the edge thereof to be inserted by the cover sheet.

In the floatable temple structure above, a periphery of the temple body has a depressed portion, and the coating member combines the external parts of the depressed portion of the temple body and the cover sheet.

In the floatable temple structure above, the coating member combines the external parts of the temple body and the cover sheet by injection coating.

In light of the foregoing described structure and embodiments of this invention, this invention has the following advantages, comparing with the conventional structure:

1. In the floatable temple structure of this invention, the design of space in the temple body and the cover sheet is used to form a space filled by gas. Therefore, the temple can float on water after the eyeglasses fall into the water, so that the user can easily find the eyeglasses.

2. In the floatable temple structure of this invention, the coating member is injected to surround the external parts of the temple body and the cover sheet, so that the temple body and the cover sheet can be tightly wrapped without falling off. Hence, the space therein can be sealed to have floating effect.

3. In the floatable temple structure of this invention, the coating member is injected to surround the external parts of the temple body and the cover sheet, so that the assembling procedure and the cost thereof can be saved.

### BRIEF DESCRIPTION OF THE DRAWINGS

FIG. 1 is a diagram showing a perspective decomposition of this invention.

FIG. 2 is a diagram showing a partial assembling appearance of this invention.

FIG. 3 is a diagram showing an overall appearance of this invention.

FIG. 4 is a diagram showing a cross-sectional view of this invention.

### DETAILED DESCRIPTION

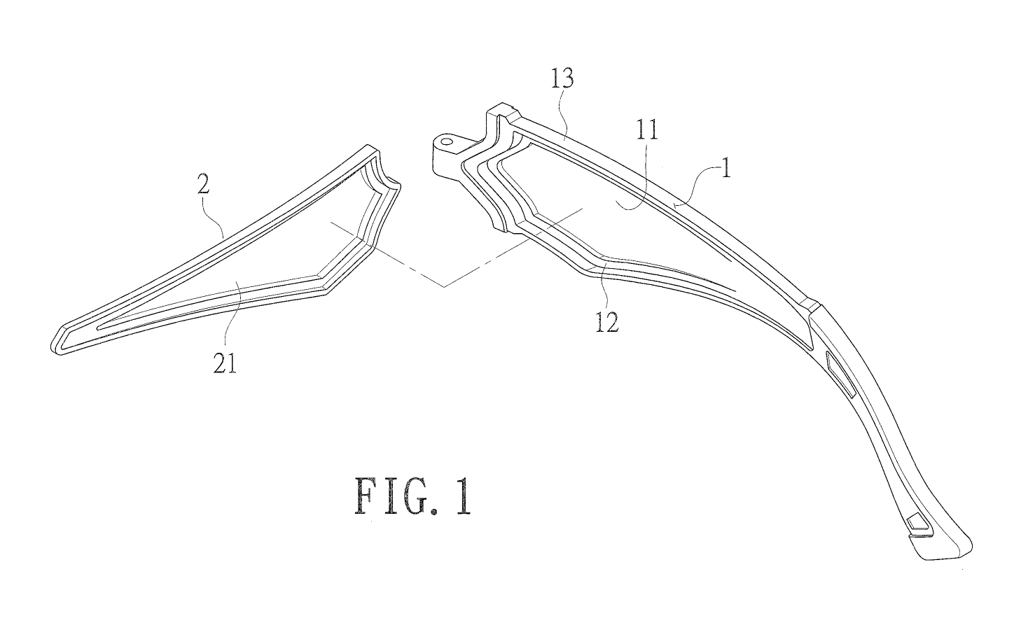

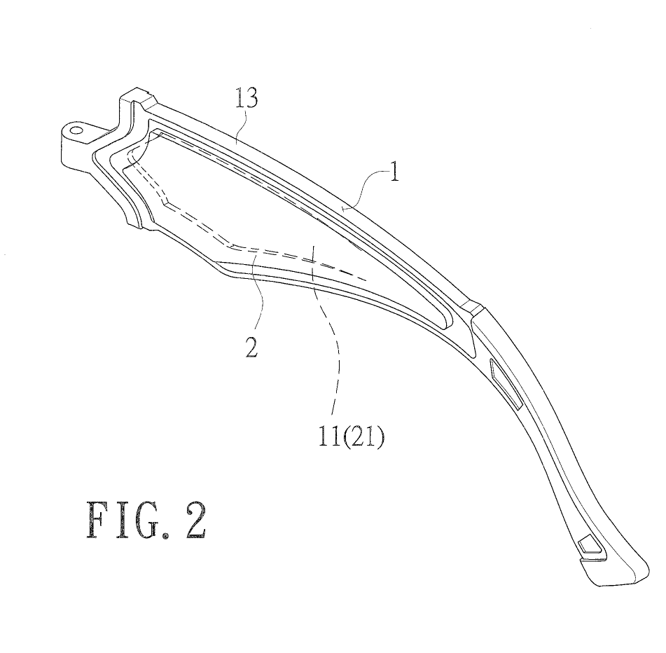

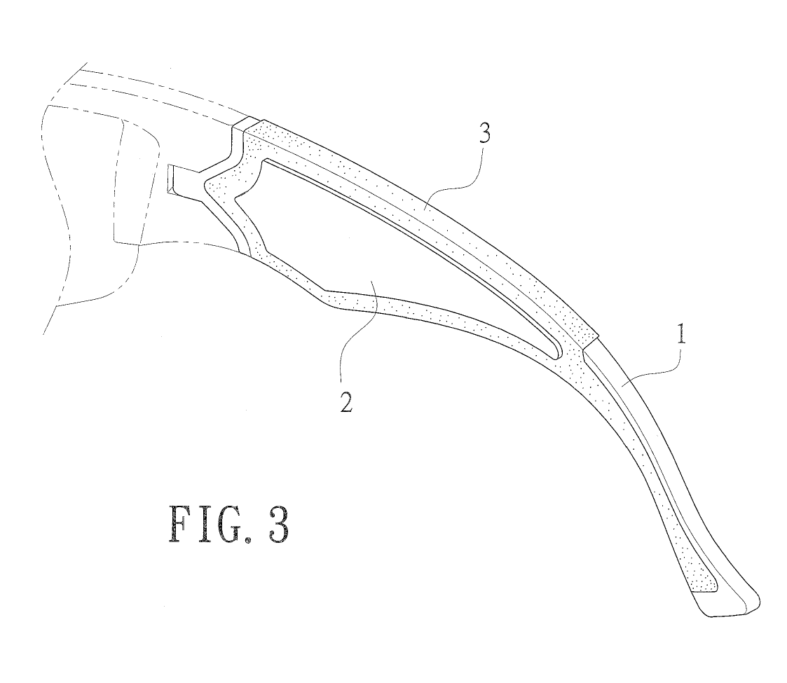

To more completely and clearly illustrate the technical means and effects of this invention, the detailed descriptions are set forth below. Please refer to the disclosed figures and the reference numbers. First, please refer to FIGS. 1-3, which are a perspective view, a decomposed view, and an assembled appearance of a floatable temple of eyeglasses according to an embodiment of this invention, respectively. The floatable temple of eyeglasses comprises:

a temple body 1 having a first space 11, wherein the opening of the first space 11 has a stepped rim 12 disposed on the edge thereof;

a cover sheet 2 inserted into the stepped rim 12 to seal the first space 11 and having a second space 21 disposed to correspond to the first space 11; and

a coating member 3 correspondingly combining the external parts of the temple body 1 and the cover sheet 2.

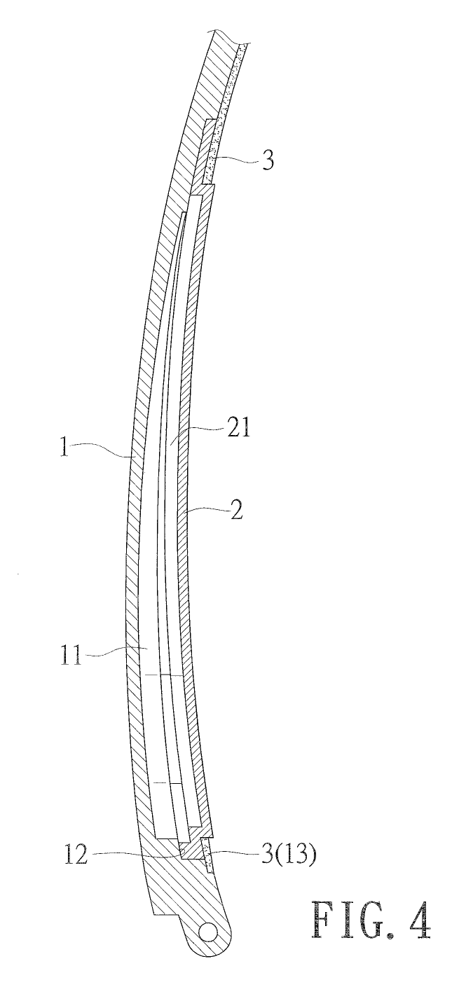

Please refer to FIGS. 1-4. When the floatable temple of eyeglasses is used, the first space 11 is disposed in the temple body 1, and the stepped rim 12 is disposed on the opening end of the first space 11. The stepped rim 12 is provided to be inserted by the cover sheet 2. Moreover, the second space 21 of the cover sheet 2 is correspondingly disposed to the first space 11, so that the first space 11 and the second space 21 can form a space for containing gas (air). Meanwhile, a depressed portion 13 is further disposed on the periphery of the temple body 1. The coating member 3 combines the external parts of the depressed portion 13 of the temple body 1 and the cover sheet 2 by injection coating.

In light of the foregoing described structure and embodiments of this invention, this invention has the following advantages, comparing with the conventional structure:

1. In the floatable temple structure of this invention, the design of space inside the temple body and the cover sheet is used to form a space filled by gas. Therefore, the temple can float on water after the eyeglasses fall into the water, so that the user can easily find the eyeglasses.

2. In the floatable temple structure of this invention, the coating member is injected to surround the external parts of the temple body and the cover sheet, so that the temple body and the cover sheet can be tightly wrapped without falling off. Hence, the space therein can be sealed to have floating effect.

3. In the floatable temple structure of this invention, the coating member is injected to surround the external parts of the temple body and the cover sheet, so that the assembling procedure and the cost thereof can be saved.

What is claimed is:

1. A floatable temple structure of eyeglasses, comprising:
a temple body having a first space, wherein an opening of the first space has a stepped rim disposed on the edge thereof;
a cover sheet inserted into the stepped rim to seal the first space, wherein the cover sheet has a second space disposed to correspond to the first space; and
a coating member correspondingly combining external parts of the temple body and the cover sheet.

2. The floatable temple structure of claim 1, wherein a periphery of the temple body has a depressed portion, and the coating member combines the external parts of the depressed portion of the temple body and the cover sheet.

3. The floatable temple structure of claim 1, wherein the coating member combines the external parts of the temple body and the cover sheet by injection coating.

4. The floatable temple structure of claim 2, wherein the coating member combines the external parts of the temple body and the cover sheet by injection coating.
